(19) United States
(12) Patent Application Publication
(10) Pub. No.: US 2020/0146314 A1
(43) Pub. Date: May 14, 2020

(54) TRACE MINERAL COMPOSITION

(71) Applicant: Nutreco IP Assets B.V., Boxmeer (NL)

(72) Inventors: Scott Fry, Indianapolis, IN (US); James Ushry, Indianapolis, IN (US); Nick Leisure, Indianapolis, IN (US); Mingsheng Huang, Indianapolis, IN (US); Fred Steward, Indianapolis, IN (US)

(21) Appl. No.: 16/632,817

(22) PCT Filed: Jul. 18, 2018
(86) PCT No.: PCT/EP2018/069546

§ 371 Date: Jan. 21, 2020

Related U.S. Application Data
(60) Provisional application No. 62/534,835, filed on Jul. 20, 2017.

(30) Foreign Application Priority Data
Sep. 14, 2017 (EP) 17191156.3

(51) Int. Cl. A23K 20/20; A23K 50/60; A23K 50/75

(52) U.S. Cl. CPC A23K 20/30; A23K 50/30; A23K 50/75; A23K 50/60

(57) ABSTRACT

A composition comprising iron(II) carbonate and a digestible binder is disclosed, wherein the composition comprises crystals of iron(II) carbonate, which are agglomerated with the digestible binder to form digestible agglomerated particles. Also disclosed is a method of preparation of such composition, as well as uses of such composition.

### CROSS-REFERENCE TO RELATED APPLICATIONS

This application is a national phase entry under 35 U.S.C. § 371 of International Patent Application PCT/EP2018/069546, filed Jul. 18, 2018, designating the United States of America and published as International Patent Publication WO 2019/016284 A1 on Jan. 24, 2019, which claims the benefit under Article 8 of the Patent Cooperation Treaty to European Patent Application Serial No. 17191156.3, filed Sep. 14, 2017, and to U.S. Provisional Patent Application Ser. No. 62/534,835, filed Jul. 20, 2017.

### TECHNICAL FIELD

This disclosure pertains to trace mineral compositions. The disclosure further pertains to animal feed comprising such trace mineral compositions.

### BACKGROUND

Trace minerals are generally added to animal feed to ensure that the animal receives the necessary trace mineral in the required amounts. Examples of such trace minerals include metal sources from copper, zinc and manganese, but also iron, cobalt, magnesium, etc. Commonly used trace mineral sources are metal salts or oxides such as copper sulphate, zinc oxide and iron sulphate, for example.

In the last years, basic metal salts have been introduced. Basic metal salts can be defined by the formula M(OH)_{y}X_{(2-y)/2}, wherein M is a metal cation, X is an anion or anionic complex and y is 1-3 depending on the valency of the anion X. Further details of such basic metal salts can be gleaned from WO 00/32206 and U.S. Pat. No. 5,451,414. Such basic metal salts generally have a higher bioavailability than the commonly used trace mineral salts. Recently, micronutrient supplements comprising agglomerates of a single basic metal salt and a digestible binder have been described in U.S. Pat. No. 8,802,180.

Iron sulphate is commonly used as the iron source in animal nutrition. This iron source has a relatively high fecal excretion level. Another disadvantage is that an excess of iron sulphate can cause oxidative stress at the gut level.

It is an object of this disclosure to provide for an improved trace mineral composition.

### BRIEF SUMMARY

In a first aspect, the present disclosure relates to a composition comprising iron(II) carbonate and a digestible binder.

In an embodiment, the composition as taught herein may further comprise a basic metal salt.

In an embodiment relating to the composition as taught herein, the composition may comprise crystals of iron(II) carbonate, which are agglomerated with the digestible binder to form digestible agglomerated particles.

In an embodiment relating to the composition as taught herein, the size of the crystals may be from 0.1 μm to 20 μm and the size of the digestible agglomerate particles may be from 50 μm to 300 μm.

In a further aspect, this disclosure relates to an animal feed comprising the composition as taught herein.

In an embodiment relating to the animal feed as taught herein, the iron(II) carbonate may be present in an amount of at most 100 ppm, preferably between 10 to 80 ppm.

In a further aspect, the disclosure relates to a premix of animal feed comprising the composition as taught herein.

In a further aspect, this disclosure relates to a feed additive comprising the composition as taught herein.

In a further aspect, the disclosure relates to a method of preparing the composition as taught herein, comprising the steps of:
(a) optionally milling iron(II) carbonate;
(b) contacting iron(II) carbonate, a digestible binder and a solvent to form a dispersion; and
(c) spray drying the dispersion to obtain the digestible agglomerated particles.

### DETAILED DESCRIPTION

The disclosure pertains to a composition comprising iron(II) carbonate and a digestible binder. This composition can be particularly suitably used in feed for monogastric animals, e.g., swine and poultry as well as feed for ruminants. The composition of the disclosure has a low dust level, which reduces the safety risk for both the animal as well as the farmer. Moreover, the iron(II) carbonate as presented to the animal in the composition of the disclosure enables a good bioavailability, which, in turn, leads to an improved hemoglobin level. The increase of the hemoglobin level is generally larger than with the conventional iron sulphate. Additionally, the fecal excretion of the iron source is reduced compared to conventional iron sulphate. In addition, the iron(II) carbonate exhibits a reduced effect on oxidative stress in the gut, especially in pigs, compared to conventional iron sulphate. A further advantage is the improved palatability of iron(II) carbonate in comparison to conventional iron sulphate. In fact, animal feed comprising the iron(II) carbonate of the disclosure is more easily and readily consumed than iron(II) sulphate-containing animal feed.

The composition may comprise iron(II) carbonate in an amount of at least 1 percent by weight (wt %), preferably at least 5 wt %, more preferably at least 10 wt %, even more preferably at least 15 wt %, and most preferably at least 20 wt %, and preferably at most 99 wt %, more preferably at most 95 wt %, even more preferably at most 90 wt %, and most preferably at most 80 wt %, based on the total weight of the composition.

The iron(II) carbonate in the composition of the disclosure may be present as a physical mixture, or be present in agglomerated particles comprising the digestible binder. In one embodiment, the composition of the disclosure comprises crystals of the iron(II) carbonate, which are agglomerated with the digestible binder to form digestible agglomerated particles. Preferably, wherein the size of the crystals is from 0.1 μm to 20 μm and the size of the digestible agglomerated particles is from 50 μm to 300 μm. The advantage of these agglomerated particles is the low dust and free flowing properties. In fact, it has been found that together with the low dust levels of the agglomerated particles, the dust particles have a much lower content of the iron(II) carbonate than observed in conventional trace mineral powders. This has a clear safety benefit for both animal and person processing the composition of the disclosure.

The size of the crystals or crystallites of iron(II) carbonate is generally at least 0.01 μm, preferably at least 0.1 μm, even more preferably at least 0.2 μm and most preferably at least 0.5 and generally at most 20 preferably at most 15 even more preferably at most 10 μm and most preferably at most 5 In one embodiment, the d90 value of the iron(II) carbonate particles is generally at least 0.01 preferably at least 0.1 even more preferably at least 0.2 μm and most preferably at least 0.5 and generally at most 20 preferably at most 15 even more preferably at most 10 μm and most preferably at most 5 Such particle sizes of iron(II) carbonate can be obtained by milling conventional iron(II) carbonate particles, in particular, siderite.

The size of the digestible agglomerated particles is generally at least 50 preferably at least 60 even more preferably at least 70 μm and most preferably at least 80 and generally at most 400 preferably at most 300 even more preferably at most 250 and most preferably at most 200 In one embodiment, the d90 value of the digestible agglomerated particles is generally at least 50 preferably at least 60 even more preferably at least 70 μm and most preferably at least 80 and generally at most 400 preferably at most 300 even more preferably at most 250 μm and most preferably at most 200 μm.

The preferred iron(II) carbonate in the composition of the disclosure is naturally occurring siderite. Also iron(II) carbonate that is synthetically produced is contemplated.

The composition of the disclosure further comprises a digestible binder. The digestible binder can be any suitable digestible binder known in the art and capable of binding the iron(II)carbonate and/or basic metal salt particles to form an agglomerated particle. Examples of such digestible binders include starches such as corn starch, potato starch, rice starch and modified derivatives thereof.

The composition may comprise the digestible binders in an amount of at least 1 percent by weight (wt %), preferably at least 2 wt %, more preferably at least 5 wt %, even more preferably at least 8 wt %, and most preferably at least 10 wt %, and preferably at most 40 wt %, more preferably at most 30 wt %, even more preferably at most 25 wt %, and most preferably at most 20 wt %, based on the total weight of the composition.

The composition of the disclosure may further comprise other trace minerals such as metal salts including basic metal salts based on copper, zinc, manganese, magnesium, calcium, iron and cobalt, as well as metal chelates, iodine and selenium sources. The composition may further comprise vitamins.

The iron(II) carbonate, the digestible binder and any other component add up to 100 wt % of the total weight of the composition.

The composition of the disclosure includes animal feed, a premix of animal feed and a feed additive. Consequently, the disclosure further pertains to a feed additive comprising the composition of the disclosure, preferably the agglomerated particles of the disclosure. Such a feed additive may comprise further ingredients commonly used in feed additives. The feed additive of the disclosure may be applied and/or added to a premix of animal feed, to animal feed and/or to drinking water. It may be applied to preserve the premix and/or the feed. The feed additive may further be used to improve the gut health of the animal.

The disclosure further pertains to a premix of animal feed comprising the composition of the disclosure, preferably the agglomerated particles of the disclosure. The premix of the disclosure may comprise further ingredients commonly used in premixes of animal feed. The premixes of the disclosure generally are further processed and further ingredients are added to form animal feed. Hence, the disclosure also pertains to an animal feed comprising the composition of the disclosure, preferably the agglomerated particles disclosed herein. The animal feed is generally fed to the animals. Animal feed generally comprises animal nutrients such as fats and/or proteins and/or carbohydrates that are fed to an animal to provide in its metabolic requirements. Animal feed can be a nutritionally complete feed (i.e., providing all required nutrients to support a normal metabolism of the animal). Similar ingredients are also contained in a premix of animal feed, which, however, contains only part of the required nutrients, and need to be mixed with other nutrients or fed separately from these other nutrients.

The amount of the iron(II) carbonate in the animal feed is generally at most 300 ppm, preferably at most 250 ppm, and most preferably at most 200 ppm, and preferably at least 80 ppm, more preferably at least 100 ppm and most preferably at least 125 ppm.

The iron(II) carbonate used in the composition of the disclosure can be prepared using any process known in the art. In one embodiment, the iron(II) carbonate is ground to the desired particle size distribution prior to blending into the composition of the disclosure. The agglomerated particles of iron(II) carbonate in accordance with the disclosure can be prepared using techniques disclosed in U.S. Pat. No. 8,802,180. For example, the agglomerated particles comprising iron(II) carbonate may be prepared by spray drying dispersions comprising iron(II) carbonate, the digestible binder and a solvent (generally water). In one embodiment, the disclosure pertains to a method of preparing the composition as taught herein comprising the steps of:
(a) optionally milling iron(II) carbonate;
(b) contacting iron(II) carbonate, a digestible binder and a solvent to form a dispersion; and
(c) spray drying the dispersion to obtain the digestible agglomerated particles.

In one embodiment of the disclosure, the composition of the disclosure further comprises a basic metal salt. Basic metal salts can be defined by the formula M(OH)_{y}X_{(2-y)/2}, wherein M is a metal cation, X is an anion or anionic group and y is 1-3 depending on the valency of the anion X. The metal cation M can be any metal ion known in the art. Examples of such metal ions include copper, zinc, manganese, iron, cobalt and magnesium. Examples of anion X include chloride, carbonate, phosphate and sulphate, preferably the anion X is chloride. The preferred basic copper salt in the composition of the disclosure is basic copper chloride, in particular, atacamite and clinoatacamite. Most preferred is a mixture of atacamite and clinoatacamite. The preferred basic zinc salt is basic zinc chloride, in particular, Simonkoellite. The preferred basic manganese salt is basic manganese chloride, in particular, Kempite. Processes to prepare the aforementioned basic metal salts can be found in U.S. Pat. No. 8,802,180, WO 00/32206 and U.S. Pat. No. 5,451,414, which are herewith included by reference. Exemplary basic metal salts that may be used in the composition as taught herein include, without limitation, dicopper chloride trihydroxide (Cu₂ (OH)₃Cl), manganese hydroxychloride (Mn₂(OH)₃Cl), and zinc hydroxychloride (“Zinc chloride hydroxide monohydrate”; Zn₅(OH)₈Cl₂.H₂O).

The (total) amount of the basic metal salt in the animal feed is generally at most 1000 ppm, preferably at most 700 ppm, and most preferably at most 500 ppm, and preferably at least 1 ppm, more preferably at least 5 ppm and most preferably at least 10 ppm.

When the basic metal salt is a basic copper salt, such as dicopper chloride trihydroxide (Cu₂(OH)₃Cl), the amount of the basic copper salt in the animal feed is generally at most 300 ppm, preferably at most 250 ppm, and most preferably at most 200 ppm, and preferably at least 80 ppm, more preferably at least 100 ppm and most preferably at least 125 ppm.

When the basic metal salt is a basic zinc salt, such as zinc hydroxychloride (“Zinc chloride hydroxide monohydrate”; Zn₅(OH)₈Cl₂.H₂O), the amount of the basic zinc salt in the animal feed is generally at most 100 ppm, preferably at most 90 ppm, and most preferably at most 80 ppm, and preferably at least 1 ppm, more preferably at least 5 ppm and most preferably at least 10 ppm.

When the basic metal salt is a basic manganese salt, such as manganese hydroxychloride (Mn₂(OH)₃Cl), the amount of the basic manganese salt in the animal feed is generally at most 100 ppm, preferably at most 90 ppm, and most preferably at most 80 ppm, and preferably at least 1 ppm, more preferably at least 5 ppm and most preferably at least 10 ppm.

The disclosure further pertains to the use of the composition of the disclosure in feeding of monogastric animals, in particular, of poultry and swine. In one aspect, the disclosure pertains to a method of feeding a monogastric animal, in particular, poultry and/or swine, by providing to the animal feed comprising the composition of the disclosure.

The disclosure further pertains to the use of the composition of the disclosure in feeding of challenged monogastric animals, in particular, of poultry and swine. In one aspect, the disclosure pertains to a method of feeding a challenged monogastric animal, in particular, poultry and/or swine, by providing to the animal feed comprising the composition of the disclosure. With the term “challenged” or “challenged animal” is meant an animal suffering from a disease or an animal having a compromised health, hemoglobin level or hematocrit level.

The disclosure further pertains to the use of the composition of the disclosure in feeding of ruminant animals, in particular, of cows. In one aspect, the disclosure pertains to a method of feeding a ruminant animal, in particular, a cow, by providing to the animal feed comprising the composition of the disclosure.

The disclosure further pertains to the use of the composition of the disclosure in feeding of challenged ruminant animals, in particular, of cows. In one aspect, the disclosure pertains to a method of feeding a challenged ruminant animal, in particular, cows, by providing to the animal feed comprising the composition of the disclosure.

The compositions of the disclosure are generally suitable for feeding monogastric animals during most part of their lives or throughout their lives. The level of the trace mineral composition may vary with the age of the animal. The animals may be fed for a certain period, e.g., in the first 20 to 28 weeks after birth, with a trace mineral composition with a higher amount of iron than at greater age. Accordingly, the disclosure also pertains to a second composition comprising iron(II) carbonate and a digestible binder, wherein the iron(II) carbonate level is at a higher level compared to a composition suitable for older animals. This composition can be particularly suitably used in feed for monogastric animals, e.g., swine and poultry.

The disclosure is illustrated with the following examples.

### EXAMPLES

### Example 1

Experiments were conducted to determine the effect of trace mineral level and source on hemoglobin, hematocrit and performance of broiler chickens. Bioavailability of iron was determined by the common-intercept multiple linear regression (slope-ratio) method (S. Aoyagi and D. H. Baker, Nutritional evaluation of a copper-methionine complex for chicks, Poult. Sci. 1993; 72:2309-15). For the first 7 days, chicks were fed a semi-purified diet based on dextrose, corn starch and casein (see Table 1), but with a low level of corn in order to encourage food intake. The calculated iron concentration was 25 ppm and the adaptation period was done in order to deplete iron stores received via the egg.

Beginning on day 7, chicks were provided experimental diets containing the three iron sources added to the basal diet as tabulated below. The three iron sources are commercial grade iron sulphate (FeSO₄) (Comparative Example A), siderite (Comparative Example B) and agglomerated particles of starch and crystallites of iron(II) carbonate (Example 1; in accordance with the disclosure) (see Table 2). The agglomerated particles were prepared by grinding siderite to a d90 value below 5 subsequently mixing the ground iron(II) carbonate, starch and water, and spray drying the dispersion. The resulting agglomerated particles have a mean particle size of 190 mm; the content of iron(II) carbonate is 36.94 wt %, based on the total weight of the agglomerated particles.

TABLE 1
Basal diet

| Ingredient | % As fed |
|---|---|
| Dextrose | 20.67 |
| Corn starch | 20.30 |
| Corn Dent Yel grain | 20.00 |
| Casein dehydrated | 15.62 |
| Cellulose | 9.00 |
| Fat, Vegetable oil | 6.05 |
| Mineral Premix- NRC w/o Fe | 0.75 |
| Vitamin mix - NRC | 0.75 |
| DL-methionine 99% | 0.54 |
| Salt | 0.53 |
| Choline chloride | 0.18 |
| Threonine | 0.17 |
| Magnesium oxide | 0.11 |
| Isoleucine | 0.07 |
| Tryptophan | 0.04 |
| Nutrient | As fed |
| ME | 3500.00 |
| Protein | 17.06 |
| Fat | 7.87 |
| Calcium | 1.10 |
| Phos. avail. | 0.50 |
| Potassium | 0.53 |
| Iron | 25.00 |

Birds were raised in Petersime batteries and all metal (feeders, waterers, raised wire floors) in contact with the birds was stainless steel. Water was deionized.

Statistical Analysis: Hemoglobin, hematocrit and performance data were regressed against dietary iron level for each source to obtain linear dose response relationships and bioavailability was calculated from the ratio of the slopes to that of FeSO₄. Data (excluding the basal treatment) was also analyzed as a 4 source×4 level factorial arrangement of treatments. Slope ratios were calculated using the 0, 15, and 25 ppm added levels.

TABLE 2
Results of the iron source treatments

| | | Level | Hemoglobin | Hematocrit | Gain | Intake | Efficiency |
|---|---|---|---|---|---|---|---|
| Ex. | Source | ppm | mg/dl | % | g/chick | g/chick | gain/feed |
| | Basal | 0 | 2.29 | 32.5 | 405.1 | 722.4 | 0.56 |
| A | Commercial | 15 | 2.86 | 38.3 | 523.9 | 888.2 | 0.59 |
| | grade FeSO4 | | | | | | |
| A | Commercial | 25 | 3.65 | 37.2 | 548.5 | 884.0 | 0.62 |
| | grade FeSO4 | | | | | | |
| 1 | Micronutrient Fe | 15 | 4.62 | 37.5 | 547.4 | 878.7 | 0.62 |
| 1 | Micronutrient Fe | 25 | 3.90 | 37.0 | 495.7 | 864.9 | 0.57 |
| B | Siderite | 15 | 2.60 | 34.7 | 430.4 | 770.2 | 0.56 |
| B | Siderite | 25 | 2.88 | 38.8 | 525.2 | 838.7 | 0.63 |

| | | | | | |
|---|---|---|---|---|---|
| Pooled SEM | 0.47 | 1.99 | 29.71 | 26.80 | 0.02 |
| All Added Levels: ANOVA* | 0.53 | 0.074 | 0.161 | 0.120 | 0.119 |
| Level | | | | | |
| Source | 0.029 | 0.780 | 0.110 | <0.001 | 0.433 |
| Main Effect Means for | | | | | |
| Iron Source | | | | | |
| (across all levels) | | | | | |
| Commercial grade FeSO4 | 3.76 ^{ab} | 37.3 | 531.8 | 867.5 ^{a} | 0.61 |
| Micronutrient Fe | 4.31 ^{a} | 36.3 | 515.9 | 863.0 ^{a} | 0.60 |
| Siderite | 2.93 ^{b} | 36.6 | 498.3 | 782.5 ^{b} | 0.63 |

When comparing the bioavailability of commercial iron sulphate (Comparative Example A) and the iron(II) carbonate-containing agglomerated particles (Example 1) reveals a higher bioavailability (136%) for the particles of Example 1 (see Table 2).

1.-8. (canceled)

9. A composition comprising:
iron(II) carbonate; and
a digestible binder,
wherein the composition comprises crystals of iron(II) carbonate, which are agglomerated with the digestible binder to form digestible agglomerated particles.

10. The composition of claim 9, further comprising:
a basic metal salt.

11. The composition of claim 9,
wherein the size of the crystals is from 0.1 μm to 20 μm, and
wherein the size of the digestible agglomerate particles is from 50 μm to 300 μm.

12. The composition of claim 10,
wherein the size of the crystals is from 0.1 μm to 20 μm, and
wherein the size of the digestible agglomerate particles is from 50 μm to 300 μm.

13. An animal feed comprising the composition of claim 9.

14. An animal feed comprising the composition of claim 10.

15. An animal feed comprising the composition of claim 11.

16. An animal feed comprising the composition of claim 12.

17. The animal feed of claim 13, wherein the iron(II) carbonate is present in an amount of at most 100 ppm.

18. The animal feed of claim 17, wherein the iron(II) carbonate is present in an amount of between 10 ppm to 80 ppm.

19. The animal feed of claim 14, wherein the iron(II) carbonate is present in an amount of at most 100 ppm.

20. The animal feed of claim 19, wherein the iron(II) carbonate is present in an amount of between 10 ppm to 80 ppm.

21. The animal feed of claim 15, wherein the iron(II) carbonate is present in an amount of at most 100 ppm.

22. The animal feed of claim 21, wherein the iron(II) carbonate is present in an amount of between 10 ppm to 80 ppm.

23. The animal feed of claim 16, wherein the iron(II) carbonate is present in an amount of at most 100 ppm.

24. The animal feed of claim 23, wherein the iron(II) carbonate is present in an amount of between 10 ppm to 80 ppm.

25. An animal feed comprising a composition, wherein the composition comprises:
crystals of iron(II) carbonate;
a digestible binder; and
a basic metal salt,
wherein the crystals of iron(II) carbonate are agglomerated with the digestible binder to form digestible agglomerated particles,
wherein the size of the crystals of iron(II) carbonate is from 0.1 μm to 20 μm,
wherein the size of the digestible agglomerate particles is from 50 μm to 300 μm, and
wherein iron(II) carbonate is present in the animal feed in an amount of between 10 ppm to 80 ppm.

26. A premix of animal feed comprising the composition of claim 9.

27. A feed additive comprising the composition of claim 9.

28. A method of preparing the composition of claim 9, the method comprising:
(a) optionally milling iron(II) carbonate;
(b) contacting iron(II) carbonate, a digestible binder, and a solvent to form a dispersion; and
(c) spray drying the dispersion to obtain digestible agglomerated particles.
